(19) United States
(12) Patent Application Publication
(10) Pub. No.: US 2024/0357709 A1
(43) Pub. Date: Oct. 24, 2024

(54) Heater Used for Vehicle and the Corresponding Electric Heating System and Seat

(71) Applicant: Gentherm GmbH, Odelzhausen (DE)

(72) Inventors: Haiming Yang, Langfang, Hebei (CN); Wei Wang, Langfang, Hebei (CN); Xiongwei Liu, Langfang, Hebei (CN); Peng Wang, Langfang, Hebei (CN)

(21) Appl. No.: 18/715,838

(22) PCT Filed: Nov. 22, 2022
(86) PCT No.: PCT/CN2022/133376

§ 371 Date: Jun. 3, 2024

(30) Foreign Application Priority Data
Dec. 3, 2021 (CN) 202123009667.2

(51) Int. Cl. H05B 3/06; B60N 2/56; H05B 1/02

(52) U.S. Cl. CPC H05B 3/06; B60N 2/5685; H05B 1/0252

(57) ABSTRACT

A heater, an electrical heating system, and a seat for a vehicle that includes: a heating electrical conductor; and a circuit board, which has a first edge and a second edge, and which has a first electrical connection zone for electrically connecting to the heating electrical conductor and a second electrical connection zone for electrically connecting to an external circuit outside the circuit board; the heating electrical conductor crosses over the first edge to electrically connect to the first electrical connection zone, and a protective structure for protecting the heating electrical conductor is provided at the first edge; and/or the second electrical connection zone is electrically connected to the external circuit via an electrical connection structure, and the electrical connection structure is mechanically fixed to the circuit board.

### TECHNICAL FIELD

This disclosure relates to a heater for a vehicle, a corresponding electrical heating system for a vehicle, and a corresponding seat for a vehicle.

### BACKGROUND ART

With the development of technology and people's increasing requirements for comfort, more and more vehicle seats are equipped with heating devices to improve the specific experience. Such seat heating is very beneficial, particularly in the cold winter, which can quickly make people feel warm.

For seat heating, heating wires are usually arranged in or under a seat, for example, a seat cushion. Heating wires serve the corresponding heating purpose by converting electrical energy into thermal energy. A corresponding temperature sensor also needs to be provided to monitor and control the seat heating process.

To this end, these components need to be connected to external power supplies and control devices. However, as a result of the characteristics of the seat per se, the connection operation is relatively difficult. In addition, corresponding components may be damaged due to repeated pressing or possible maintenance operations. And it has been found in practice that the points of electrical connection are more easily damaged.

For this reason, corresponding improvements are needed.

### SUMMARY OF THE DISCLOSURE

In order to overcome the aforementioned drawbacks and other possible drawbacks, an aim of the present disclosure is to provide an improved heater for a vehicle, a corresponding electrical heating system for a vehicle, and a corresponding seat for a vehicle.

According to a first aspect of the disclosure, there is provided a heater for a vehicle, wherein the heater comprises: a heating electrical conductor, which forms a heating circuit for heating in a heating zone; and a circuit board, which has a first edge and a second edge different from the first edge, and which has a first electrical connection zone for electrically connecting to the heating electrical conductor and a second electrical connection zone for electrically connecting to an external circuit outside the circuit board; wherein the heating electrical conductor crosses the first edge to electrically connect to the first electrical connection zone, and a protective structure for protecting the heating electrical conductor is provided at the first edge; and/or wherein the second electrical connection zone is electrically connected to the external circuit via an electrical connection structure, and the electrical connection structure is mechanically fixed to the circuit board.

According to an optional embodiment of the disclosure, the first edge and the second edge are arranged oppositely; and/or the circuit board is a printed circuit board.

According to an optional embodiment of the disclosure, the heating electrical conductor comprises a first section cladded with an insulating layer and a second section not cladded with any insulating layer, the heating electrical conductor is electrically connected to the first electrical connection zone via the second section, and the first section is arranged across the first edge in such a manner that the protective structure comprises the insulating layer located at the first edge on the first section; and/or the electrical connection structure is configured to be in plug-in connection to the external circuit; and/or the circuit board is a flexible circuit board.

According to an optional embodiment of the disclosure, the first edge has a beveled structure at least in an area where the heating electrical conductor passes so that the protective structure comprises the beveled structure; and/or the electrical connection structure is configured as a socket; and/or a portion of the first section of the heating electrical conductor is attached to the circuit board.

According to an optional embodiment of the disclosure, the beveled structure includes a rounded edge-beveled structure and/or a chamfer structure; and/or the electrical connection structure comprises an engaging structure for engaging with the circuit board so that the electrical connection structure is mechanically fixed to the circuit board; and/or the electrical connection structure is arranged across the second edge; and/or a portion of the first section of the heating electrical conductor is attached to the circuit board by adhesion.

According to an optional embodiment of the disclosure, the engaging structure comprises a first plug-in structure used only for establishing a mechanical connection to the circuit board and/or a second plug-in structure used for establishing an electrical connection and a mechanical connection to the circuit board simultaneously.

According to an optional embodiment of the disclosure, the first plug-in structure is configured to transfer at least part of a force, which acts on the electrical connection structure, directly to the circuit board; and/or the first plug-in structure comprises at least one pillar adapted to be plugged into a first through hole on the circuit board; and/or the second plug-in structure comprises a plurality of pins each adapted to be plugged into a corresponding second through hole on the circuit board.

According to an optional embodiment of the disclosure, the first through hole is located between the second electrical connection zone and the second edge; and/or the first through hole is arranged adjacent to the second edge; and/or the at least one pillar includes two pillars; and/or the plurality of pins includes four pins; and/or the pins are fixed into the second through holes by soldering.

According to an optional embodiment of the disclosure, the circuit board comprises a first side and a second side opposite thereto, wherein the first electrical connection zone is formed on the first side, and the electrical connection structure is mounted to the circuit board from the second side; and/or the heating circuit comprises at least one heating loop, both ends of which are connected to the circuit board.

According to an optional embodiment of the disclosure, the heater further comprises a cover covering at least a portion of the first side of the circuit board; and/or the heater further comprises a temperature sensor arranged on the circuit board.

According to an optional embodiment of the disclosure, the temperature sensor is arranged on the first side of the circuit board; and/or the temperature sensor is arranged between two ends of the heating loop; and/or the temperature sensor is spaced apart from the first electrical connection zone and from the second electrical connection zone; and/or a portion of the heating electrical conductor is arranged on the first side of the circuit board, around the temperature sensor.

According to an optional embodiment of the disclosure, the temperature sensor and/or the first electrical connection zone are each electrically connected to the second electrical connection zone via a corresponding printed wire formed on the first side of the circuit board; and/or the heating electrical conductor is arranged on a carrier and thus forms the heating zone.

According to an optional embodiment of the disclosure, the heater is configured to heat a seat of the vehicle.

According to a second aspect of the disclosure, provided is an electrical heating system for a vehicle, which electrical heating system comprises the heater.

According to a third aspect of the disclosure, provided is a seat for a vehicle, which seat comprises the heater or the electrical heating system.

According to some embodiments of the disclosure, the installation operation is simplified, and the performance reliability is also improved.

### BRIEF DESCRIPTION OF THE DRAWINGS

The principles, characteristics and advantages of the present disclosure can be better understood by describing the disclosure in greater detail with reference to the accompany drawings, in which:

FIG. 1 shows a schematic diagram of a heater for a vehicle according to an exemplary embodiment of the disclosure.

FIG. 2 schematically shows a side view of a part of the heater shown in FIG. 1.

FIG. 3 shows a schematic diagram of the heater shown in FIG. 1. Compared with FIG. 1, FIG. 3 schematically shows a cover with a dotted line and provides a corresponding temperature sensor.

FIG. 4 shows a view of the other side of the heater shown in FIGS. 1 and 3.

### DETAILED DESCRIPTION OF EMBODIMENTS

For a clearer understanding of the technical problems to be solved, technical solutions and advantageous technical effects of the disclosure, the disclosure will be described below in greater details in conjunction with the drawings and a number of exemplary embodiments. It is to be understood that specific embodiments described herein are merely for explaining the disclosure, rather than limiting the scope thereof.

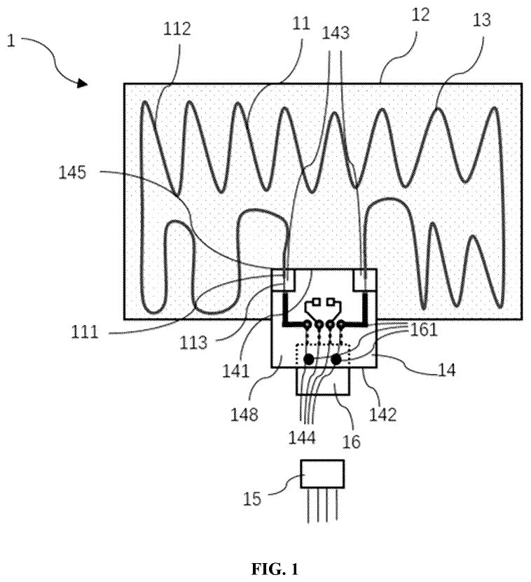

FIG. 1 shows a schematic diagram of a heater for a vehicle according to an exemplary embodiment of the disclosure.

Before proceeding to the detailed description, it should be noted that for the sake of clarity, the description is mainly focused on the parts involved in the disclosure, and the description of other parts that may cause confusion is omitted or simplified.

Before proceeding to the detailed description, it should be noted that for the sake of clarity, the description is mainly focused on parts involved in this disclosure, while the description of other parts that may cause confusion is omitted or simplified.

First, according to one aspect of the disclosure, as shown in FIG. 1, there is provided a heater 1 for a vehicle, comprising: a heating electrical conductor 11, which forms a heating circuit 13 for heating in a heating zone 12; and a circuit board 14, which has a first edge 141 and a second edge 142 different from the first edge 141, and which has a first electrical connection zone 143 for electrically connecting to the heating electrical conductor 11 and a second electrical connection zone 144 for electrically connecting to an external circuit 15 outside the circuit board 14; wherein the heating electrical conductor 11 crosses the first edge 141 to electrically connect to the first electrical connection zone 143, and a protective structure 145 for protecting the heating electrical conductor 11 is provided at the first edge 141; and/or wherein the second electrical connection zone 144 is electrically connected to the external circuit 15 via an electrical connection structure 16, and the electrical connection structure 16 is mechanically fixed to the circuit board 14. The external circuit 15 may be used for providing electrical energy, or it may also be used for controlling the supply of electrical energy to the heating electrical conductor 11. The external circuit may be connected to an electronic control unit (ECU) of the vehicle.

Here, the “protection” in the “protective structure 145” refers to reducing or avoiding the possibility that in use the heating electrical conductor 11 passing the first edge 141 is damaged in an area of the first edge 141 and thus loses its electrical function.

The term “mechanically fixed” used here means that the electrical connection structure 16 is fixed to the circuit board 14 in a mechanical way, which is different from material bonding such as welding.

According to an exemplary embodiment of the disclosure, the heater 1 is configured to heat a seat of a vehicle. In this case, the heating zone 12 may be located under a seat bottom of the seat. Of course, this is simply an exemplary application scenario.

According to an exemplary embodiment of the disclosure, as shown in FIG. 1, the first edge 141 and the second edge 142 are arranged oppositely.

According to an exemplary embodiment of the disclosure, the circuit board 14 may be a printed circuit board, in particular a flexible printed circuit board.

According to an exemplary embodiment of the disclosure, as shown in FIG. 1, the heating electrical conductor 11 comprises a first section 112 cladded with an insulating layer 111, with a larger diameter in the drawing, and a second section 113 not cladded with any insulating layer 111, with a smaller diameter in the drawing; the heating electrical conductor 11 is electrically connected, such as by welding, to the first electrical connection zone 143 via the second section 113, and the first section 112 is arranged across the first edge 141 in such a manner that the protective structure 145 comprises the insulating layer 111 located at the first edge 141 on the first section 112. In other words, in this case, the insulating layer 111 can play a protective role. It can be seen that the heating electrical conductor 11 can be produced by using a simple sheathed wire. This is out of the consideration of how to reduce the damaging effect of the edge of the first edge 141, from the perspective of the heating electrical conductor 11.

According to an exemplary embodiment of the disclosure, the electrical connection structure 16 is configured to be in plug-in connection to the external circuit 15, and is particularly configured as a socket. As a result, the external circuit 15 may be provided with a corresponding plug. This plug-in connection is particularly suitable for assembling operation.

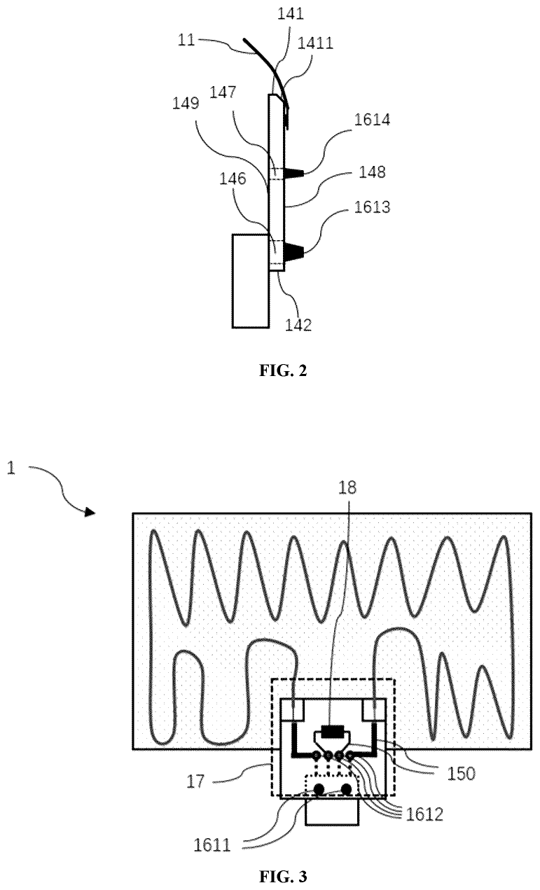

FIG. 2 schematically shows a side view of a part of the heater shown in FIG. 1.

According to an exemplary embodiment of the disclosure, as shown in FIG. 2, the first edge 141 has a beveled structure 1411 at least in an area where the heating electrical conductor 11 passes so that the protective structure 145 comprises the beveled structure 1411. Those skilled in the art can understand that although the beveled structure 1411 shown in FIG. 2 is in the form of a chamfer, the beveled structure 1411 may also include a rounded edge-beveled structure or a combination of a rounded edge-beveled structure and a chamfer-beveled structure.

According to an exemplary embodiment of the disclosure, a portion of the first section 112 of the heating electrical conductor 11 is attached to the circuit board 14. This for one thing can provide a more accurate measurement result for the temperature sensor disposed on the circuit board 14 for measuring temperature, and for another thing can prevent the heating electrical conductor 11 from falling off the circuit board 14, and also it particularly can protect the electrical connection between the heating electrical conductor 11 and the first electrical connection zone 143.

Particularly, according to an exemplary embodiment of the disclosure, a portion of the first section 112 of the heating electrical conductor 11 is attached to the circuit board 14 by adhesive bonding. In this case, adhesion can be easily achieved with glue or double-sided tape.

According to an exemplary embodiment of the disclosure, the electrical connection structure 16 comprises an engaging structure 161 for engaging with the circuit board 14 so that the electrical connection structure 16 is mechanically fixed to the circuit board 14.

According to an exemplary embodiment of the disclosure, as shown in FIGS. 1 and 2, the electrical connection structure 16 is arranged across the second edge 142.

FIG. 3 shows a schematic diagram of the heater shown in FIG. 1. Compared with FIG. 1, FIG. 3 schematically shows a cover with a dotted line and provides a corresponding temperature sensor, which will be described in further detail below.

According to an exemplary embodiment of the disclosure, as shown in FIG. 3, the engaging structure 161 comprises a first plug-in structure 1611 used only for establishing a mechanical connection to the circuit board 14 and/or a second plug-in structure 1612 used for establishing an electrical connection and a mechanical connection to the circuit board 14 simultaneously.

Particularly, the first plug-in structure 1611 is configured to transfer at least part of, in particular all of, an external force which acts on the electrical connection structure 16 directly to the circuit board 14. In this case, if the circuit board 14 itself is well fixed, the electrical connection operation between the electrical connection structure 16 and the external circuit 15, such as plugging and unplugging operations, will not affect or destroy the electrical connections elsewhere.

As shown in FIG. 2, the first plug-in structure 1611 comprises at least one pillar 1613 adapted to be plugged into a first through hole 146 on the circuit board 14. Similarly, the second plug-in structure 1612 comprises a plurality of pins 1614 each adapted to be plugged into a corresponding second through hole 147 on the circuit board 14. Here, the first through hole 146 and the second through hole 147 are schematically shown with dotted lines.

As shown in FIGS. 1 and 3, according to an exemplary embodiment of the disclosure, the first through hole 146 is located between the second electrical connection zone 144 and the second edge 142. In this case, the acting force exerted on the electrical connection structure 16 is primarily borne by cooperation between the pillar 1613 and the first through hole 146.

According to an exemplary embodiment of the disclosure, the first through hole 146 is arranged adjacent to the second edge 142.

According to an exemplary embodiment of the disclosure, as shown in FIGS. 1 and 3, the at least one pillar 1613 includes two pillars 1613.

As shown in FIGS. 1 and 3, the plurality of pins 1614 may include four pins 1614.

Preferably, an inner wall of the second through hole 147 is covered with a conductive layer, such as a copper layer, so that an electrical connection is automatically established particularly when the pin 1614 is inserted into the second through hole 147. For a more reliable electrical connection, the pin 1614 may be further fixed into the second through hole 147 by soldering.

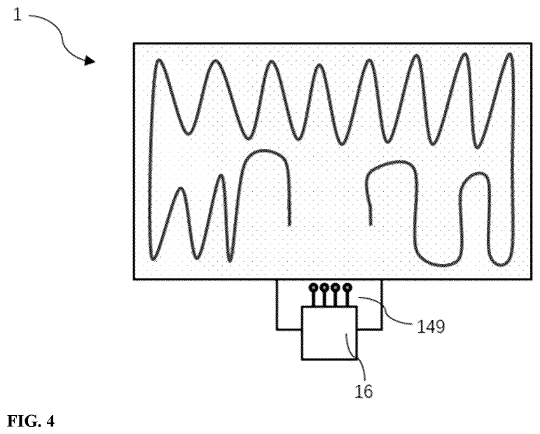

FIG. 4 shows a view of the other side of the heater shown in FIGS. 1 and 3.

According to an exemplary embodiment of the disclosure, the circuit board 14 comprises a first side 148 and a second side 149 opposite thereto, wherein the first electrical connection zone 143 is formed on the first side 148, and the electrical connection structure 16 is mounted to the circuit board 14 from the second side 149.

As shown in FIGS. 1, 3 and 4, the heating circuit 13 is here schematically shown forming a heating loop, both ends of which are connected to the circuit board 14. However, the present disclosure is not limited to this, and it is possible that a plurality of such heating circuits are provided.

As shown in FIG. 3, the heater 1 may further comprise a cover 17, shown with a dotted line, covering at least a portion of the first side 148 of the circuit board 14. In this case, some exposed electrical connection points can be avoided.

In order to monitor and control the heating operation, as shown in FIG. 3, according to an exemplary embodiment of the disclosure, the heater 1 further comprises a temperature sensor 18 arranged on the circuit board 14. The temperature sensor 18 may be a surface mount element.

According to an exemplary embodiment of the disclosure, the temperature sensor 18 may be arranged on the first side 148 of the circuit board 14.

According to an exemplary embodiment of the disclosure, the temperature sensor 18 is arranged between two ends of the heating loop.

According to an exemplary embodiment of the disclosure, the temperature sensor 18 is spaced apart from the first electrical connection zone 143 and from the second electrical connection zone 144.

According to an exemplary embodiment of the disclosure, a portion of the heating electrical conductor 11 is arranged on the first side 148 of the circuit board 14, around the temperature sensor 18 (this case is not shown). In this case, the heating electrical conductor 11 covered by the circuit board 14 can be attached to the first side 148 of the circuit board 14, for example by adhesive bonding, as described above.

As shown in FIGS. 1 and 3, the temperature sensor 18 and/or the first electrical connection zone 143 are each electrically connected to the second electrical connection zone 144 via a corresponding printed wire 150 formed on the first side 148 of the circuit board 14.

According to an exemplary embodiment of the disclosure, the heating electrical conductor 11 may be arranged on a carrier and thus forms the heating zone 12. The carrier may be any suitable material, such as fabric, etc. The heating electrical conductor 11 may even be woven into the fabric.

According to a second aspect of the disclosure, there is provided an electrical heating system for a vehicle, which electrical heating system comprises the aforementioned heater 1.

According to a third aspect of the disclosure, there is provided a seat for a vehicle, which seat comprises the aforementioned electrical heating system.

While specific embodiments of the disclosure have been described in detail here, they have been presented only for the purpose of explanation and should not be construed as limitations on the scope of the disclosure. Various substitutions, changes and modifications can be devised without deviating from the spirit and scope of the present disclosure.

1. A heater for a vehicle, wherein the heater comprises:
a heating electrical conductor, which forms a heating circuit for heating in a heating zone; and
a circuit board, which has a first edge and a second edge different from the first edge, and which has a first electrical connection zone for electrically connecting to the heating electrical conductor and a second electrical connection zone for electrically connecting to an external circuit outside the circuit board;
wherein the second electrical connection zone is electrically connected to the external circuit via an electrical connection structure, and the electrical connection structure is mechanically fixed to the circuit board.

2. The heater according to claim 16, wherein the first edge and the second edge are arranged oppositely; and/or the circuit board is a printed circuit board.

3. The heater according to claim 2, wherein
the heating electrical conductor comprises a first section cladded with an insulating layer and a second section not cladded with any insulating layer, the heating electrical conductor is electrically connected to the first electrical connection zone via the second section, and the first section is arranged across the first edge in such a manner that the protective structure comprises the insulating layer located at the first edge on the first section; and/or
the electrical connection structure is configured to be in plug-in connection to the external circuit; and/or
the circuit board is a flexible circuit board.

4. The heater according to claim 3, wherein
the first edge has a beveled structure at least in an area where the heating electrical conductor passes so that the protective structure comprises the beveled structure; and/or
the electrical connection structure is configured as a socket; and/or a portion of the first section of the heating electrical conductor is attached to the circuit board.

5. The heater according to claim 4, wherein
the beveled structure includes a rounded beveled structure and/or a chamfer structure; and/or
the electrical connection structure comprises an engaging structure for engaging with the circuit board so that the electrical connection structure is mechanically fixed to the circuit board; and/or
the electrical connection structure is arranged across the second edge; and/or
a portion of the first section of the heating electrical conductor is attached to the circuit board by adhesive bonding.

6. The heater according to claim 5, wherein the engaging structure comprises a first plug-in structure used only for establishing a mechanical connection to the circuit board and/or a second plug-in structure -used for establishing an electrical connection and a mechanical connection to the circuit board simultaneously.

7. The heater according to claim 6, wherein
the first plug-in structure is configured to transfer at least part of a force, which acts on the electrical connection structure, directly to the circuit board; and/or
the first plug-in structure comprises at least one pillar adapted to be plugged into a first through hole on the circuit board; and/or
the second plug-in structure comprises a plurality of pins each adapted to be plugged into a corresponding second through hole on the circuit board.

8. The heater according to claim 7, wherein
the first through hole is located between the second electrical connection zone and the second edge; and/or
the first through hole is arranged adjacent to the second edge; and/or
the at least one pillar includes two pillars; and/or
the plurality of pins includes four pins; and/or
the pins are fixed into the second through holes by soldering.

9. The heater according to claim 1, wherein
the circuit board comprises a first side and a second side opposite thereto, wherein the first electrical connection zone is formed on the first side, and the electrical connection structure is mounted to the circuit board from the second side; and/or
the heating circuit comprises at least one heating loop, both ends of which are connected to the circuit board.

10. The heater according to claim 9, wherein
the heater further comprises a cover covering at least a portion of the first side of the circuit board; and/or
the heater further comprises a temperature sensor arranged on the circuit board.

11. The heater according to claim 10, wherein
the temperature sensor is arranged on the first side of the circuit board; and/or
the temperature sensor is arranged between two ends of the heating loop; and/or
the temperature sensor is spaced apart from the first electrical connection zone and from the second electrical connection zone; and/or
a portion of the heating electrical conductor is arranged on the first side of the circuit board, around the temperature sensor.

12. The heater according to claim 11, wherein
the temperature sensor and/or the first electrical connection zone are each electrically connected to the second electrical connection zone via a corresponding printed wire formed on the first side of the circuit board; and/or
the heating electrical conductor is arranged on a carrier and thus forms the heating zone.

13. The heater according to claim 1, wherein the heater is configured to heat a seat of the vehicle.

14. An electrical heating system for a vehicle, wherein the electrical heating system comprises the heater according to claim 1.

15. A seat for a vehicle, wherein the seat comprises the heater according to claim 1.

16. The heater according to claim 1, wherein the heating electrical conductor crosses the first edge to electrically connect to the first electrical connection zone, and a protective structure for protecting the heating electrical conductor is provided at the first edge.
